(19) United States
(12) Patent Application Publication
(10) Pub. No.: US 2016/0306252 A1
(43) Pub. Date: Oct. 20, 2016

(54) POLARIZABLE INTERIOR-TRIMMING WINDOW INCLUDING AT LEAST ONE PRINTED CIRCUIT

(71) Applicant: VISION SYSTEMS AERONAUTICS, Brignais (FR)

(72) Inventors: Georges FIGURA, Brignais (FR); Laurent COSTA, Lyon (FR)

(21) Appl. No.: 14/783,821

(22) PCT Filed: Mar. 26, 2014
(86) PCT No.: PCT/FR2014/050715

§ 371 Date: Oct. 9, 2015

(30) Foreign Application Priority Data
Apr. 9, 2013 (FR) 13/53188

(51) Int. Cl. G02F 1/17; G02F 1/01; B64C 1/14

(52) U.S. Cl. CPC G02F 1/172; B64C 1/1484; B64C 1/1492; G02F 1/0121

(57) ABSTRACT

The invention relates to an interior-trimming window (9) forming a panel (13) including at least one translucent wall (17, 19) and at least one polarizable film which is applied onto the wall (17, 19) and which is to vary the degree to which the panel (13) is opaque. The interior trimming window (9) further includes a device for applying a voltage to the polarizable film, wherein the voltage application device includes at least one printed circuit provided with a flexible portion, the printed circuit being connected to a power supply circuit. A portion of the printed circuit is arranged beyond the area opposite the first outer surface (15) of the panel (13), said portion being rigid and/or flexible.

### TECHNICAL FIELD

The present invention concerns an interior trim window comprising a polarizable film arranged to vary the degree of obscuration of the light crossing said window.

### BACKGROUND

It is known to use a window comprising a polarizable film. The polarizable film is disposed over an inner layer of the window and is arranged to vary the degree of opacity of the window.

The degree of opacity of the window may vary from transparency to full opacity. For this purpose, the polarizable film comprises at least one polarized conductive layer. This polarized conductive layer is subjected to a power supply. The power variation of the power supply causes the variation of the degree of opacity. Thus, it is possible to adjust the light intensity crossing the window. This system is satisfactory in that the degree of opacity of the window may be adjusted according to the external brightness.

However, such a system also comprises a remote control sub-assembly. The control sub-assembly is arranged to electrically supply the conductive layer and to vary the voltage. The control sub-assembly comprises also additional members such as adjusting buttons of the degree of opacity.

Thus, it seems difficult to replace an existing window, devoid of a polarizable film, with a window comprising a polarizable film. Indeed, a structure for docking a window which is intended to a window devoid of a polarizable film, will not necessarily comprise enough space to insert a window with a polarizable film.

Moreover, although a dedicated docking structure comprises a location corresponding to a window with a polarizable film, joining and maintaining the remote control sub-assembly may be complex. In particular, the accessibility to the control sub-assembly may require long maintenance operations, whether for repairing an element of the control sub-assembly or for replacing said sub-assembly with a new sub-assembly.

### BRIEF SUMMARY

The present invention aims to resolve all or part of the above-mentioned drawbacks.

In the present text, the verbs join , connect , link , supply and their derivatives relate to an electrical communication between two distinct components.

For this purpose, the present invention concerns an interior trim window forming a panel comprising at least one translucent wall and at least one polarizable film applied onto the wall and intended to modify the degree of opacity of the panel.

The interior trim window further comprises a device for applying voltage to the polarizable film, the voltage applying device comprising at least one printed circuit provided with a flexible portion, the printed circuit and being linked to a power supply circuit.

The polarizable film comprises a plurality of superimposed layers having at least two conductive layers surrounding a layer made of polarizable material, the conductive layers being linked to the voltage applying device by at least one conductive track.

A portion of the printed circuit is disposed beyond the area facing the first exterior face of the panel, said portion being rigid and/or flexible.

According to one aspect of the invention, the interior trim window comprises a conductive track linked to a conductive layer of the polarizable film by bonding.

The bonding ensures a robust electrical link between the conductive track and the conductive layer.

According to one aspect of the invention, the polarizable film comprises a connection location having a contact area belonging to at least one conductive layer.

Preferably, each conductive layer comprises at least one contact area.

According to one aspect of the invention, the interior trim window comprises a first electrical link member presenting an exterior shape complementary to the connection location, the first electrical link member being applied onto the printed circuit.

According to one aspect of the invention, the interior trim window comprises control elements of the device for applying voltage to the polarizable film, the control elements being disposed so as to be operable by a contact on a first exterior face of the panel.

Preferably, the control elements comprise inductive and/or capacitive type touch keys.

According to one aspect of the invention, the interior trim window, the control elements are integrated into the flexible portion of the printed circuit.

According to one aspect of the invention, the interior trim window comprises signaling elements.

The signaling elements are intended to report on the transparency state of the polarizable film.

According to one aspect of the invention, the signaling elements comprise light elements.

According to one aspect of the invention, the light elements are provided with light-emitting diodes.

According to one aspect of the invention, the light-emitting diodes are applied onto the flexible portion of the printed circuit.

According to one aspect of the invention, the flexible portion of the printed circuit comprises a processing unit arranged to drive the adjustment of the degree of opacity of the panel.

According to one aspect of the invention, the flexible portion of the printed circuit extends opposite the first exterior face of the panel.

According to one aspect of the invention, said portion of the printed circuit is rigid and comprises the voltage applying device.

The present invention concerns also a polarizable window system comprising a receiving cassette, and a trim window, the receiving cassette comprising a housing intended to receive at least part of the device for applying voltage to the polarizable film.

Through the arrangements according to the invention, the window constitutes an industrializable assembly, which does not require complex manufacturing steps, and which may form a self-contained assembly intended to be integrated to a support structure and linked to a power supply source.

### BRIEF DESCRIPTION OF THE DRAWINGS

In any case, the invention will be well understood through the following description with reference to the annexed schematic drawing representing, as a non limiting example, an embodiment of this window.

FIG. 1 is a perspective view of a receiving cassette of a window, according to a first embodiment.

FIG. 2 is a front view of the receiving cassette of the window, according to the first embodiment.

FIG. 3 is a side view of the receiving cassette of the window, according to the first embodiment.

FIG. 4 is a front view of an interior trim window comprising a polarizable film, according to the first embodiment.

FIG. 5 is a sectional view of the interior trim window comprising a control sub-assembly, according to the first embodiment.

FIG. 6 is a perspective view of the interior trim window, according to the first embodiment.

FIG. 7 is a perspective view of the control sub-assembly, according to the first embodiment.

FIG. 8 is a sectional view of a panel of the interior trim window.

FIG. 9 is a sectional view of a polarizable film, according to the first embodiment.

FIG. 10 is a sectional view of a bonding of a conductive track to a polarizable film, according to the first embodiment.

FIG. 11 is a sectional view of the interior trim window comprising a control sub-assembly, according to a second embodiment.

FIG. 12 is a front view of the receiving cassette of the window, according to the second embodiment.

### DETAILED DESCRIPTION

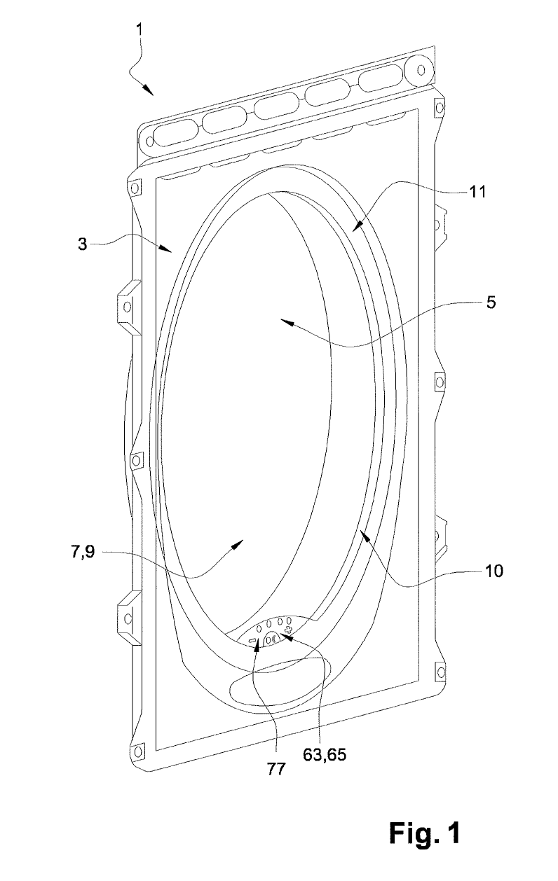

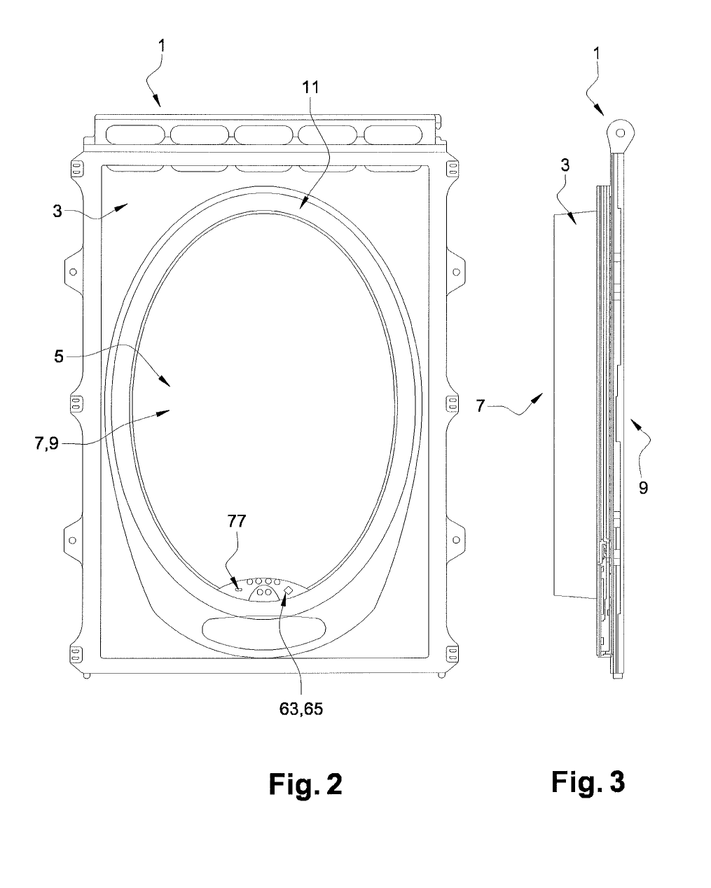

As illustrated in FIGS. 1 to 3 and according to the first embodiment, a polarizable window system 1 for an aircraft comprises a receiving cassette 3 for a window. An opening 5 is arranged in the receiving cassette 3. The system 1 comprises also an exterior structural window 7 and an interior trim window 9.

The exterior structural window 7 is situated on the side of the receiving cassette 3 overlooking the exterior of the aircraft and the interior trim window 9 is situated on the side of the receiving cassette 3 overlooking the interior of the aircraft. The exterior structural window 7 is distant from the interior trim window 9.

The system 1 further comprises a maintaining ring 11 of the interior trim window 9 in a housing 10 of the receiving cassette 3. The maintaining ring 11 presents a shape corresponding to the contour of the interior trim window 9.

The maintaining ring 11 is provided with a removable fixing member on the receiving cassette 3. The maintaining ring 11 is arranged to maintain in position the interior trim window 9 when the removable fixing member secures the maintaining ring 11 to the receiving cassette 3.

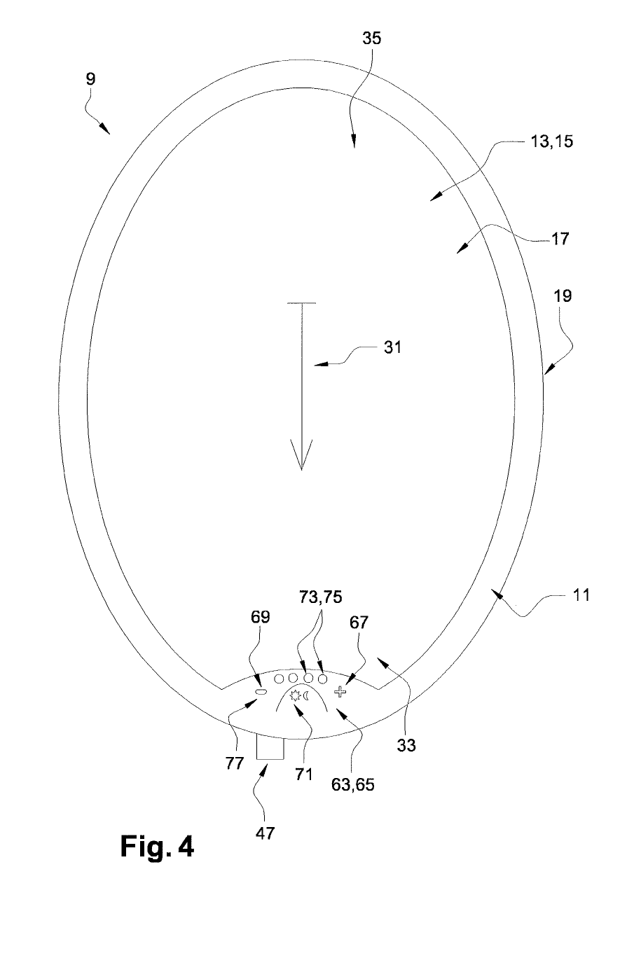

As illustrated in FIG. 4, the interior trim window 9 comprises a panel 13. The panel 13 is substantially flat and presents an ovoid-shaped contour. The panel 13 comprises a plurality of layers and has a thickness resulting from the staking of said layers.

We may thus distinguish a first exterior face 15 of the panel 13 overlooking the interior of the aircraft and a second exterior face of the panel 13 being opposite the exterior structural window 7.

The panel 13 comprises a plurality of layers. The panel 3 comprises tow extreme walls 17, 19 constituted by a translucent material. According to the presented embodiment, the translucent material is a polycarbonate.

The panel 13 comprises an inner layer 21 surrounded by the walls 17, 19. The inner layer 21 is secured to the walls 17, 19, the securing being carried out by a transparent adhesive layer 24.

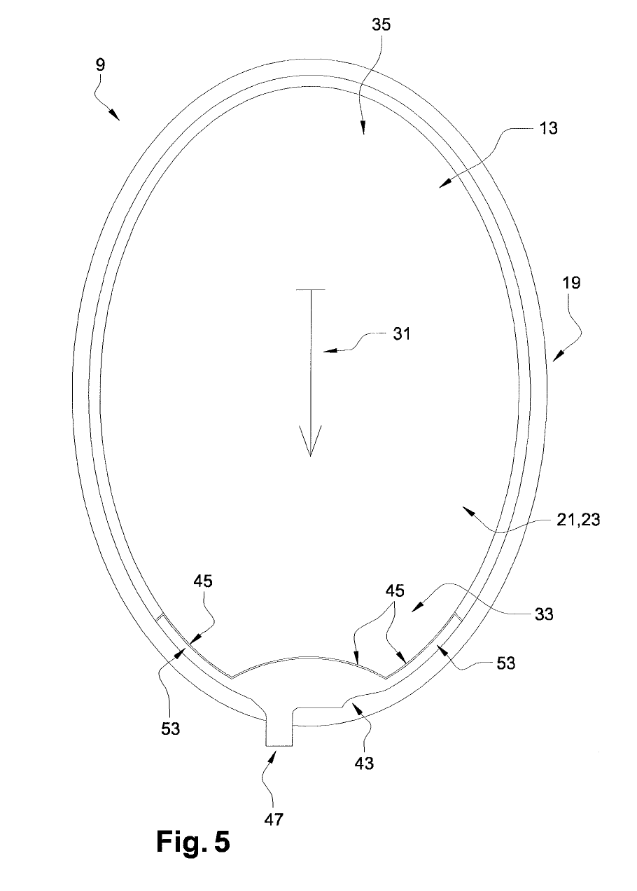

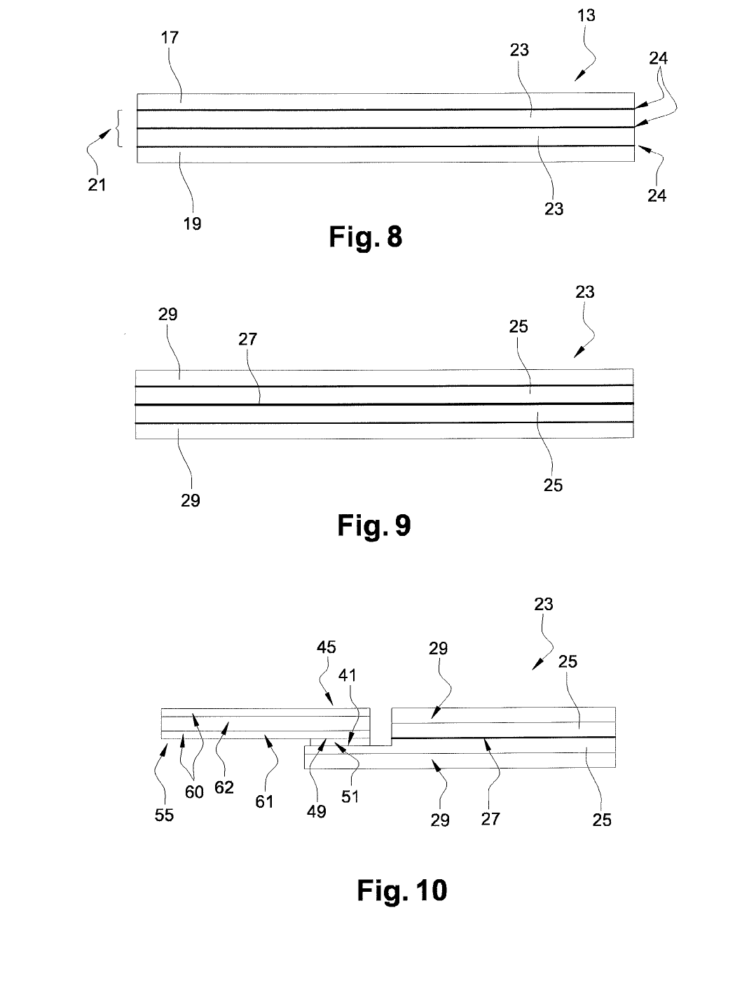

As illustrated in FIGS. 5 and 8, the inner layer 21 comprises at least one polarizable film 23. According to the first embodiment, the inner layer 21 comprises two superimposed polarizable films 23. A transparent adhesive layer 24 ensures the securing together the two polarizable films 23.

Each polarizable film 23 constitutes a thickness of the inner layer 21 and extends opposite the exterior faces 15 of the interior trim window 9.

As illustrated in FIG. 9, each polarizable film 23 comprises two transparent conductive layers 25 between which there is a layer of a polarizable material 27. The conductive layers 25 extend also opposite the exterior faces 15 of the interior trim window 9.

According to the first embodiment, the polarizable material layer 27 is of the [symbol] suspended particle device [symbol] type. The polarizable material layer 27 is arranged to change the degree of opacity according to the power supply imposed on said material by the two conductive layers 25 that surround it. The opacity is obtained by a polarization of said material, the polarization varying according to the power supply subjected to the two conductive layers 25.

The conductive layers 25 are surrounded by transparent insulating layers 29. According to the first embodiment, the transparent insulating layers 29 are made of polyimide.

As illustrated in FIGS. 1 to 6, the ovoid shape of the interior trim window 9 presents a main direction of extension 31. A first 33 and a second 35 ends of the interior trim window 9 are defined according to the main direction of extension 31.

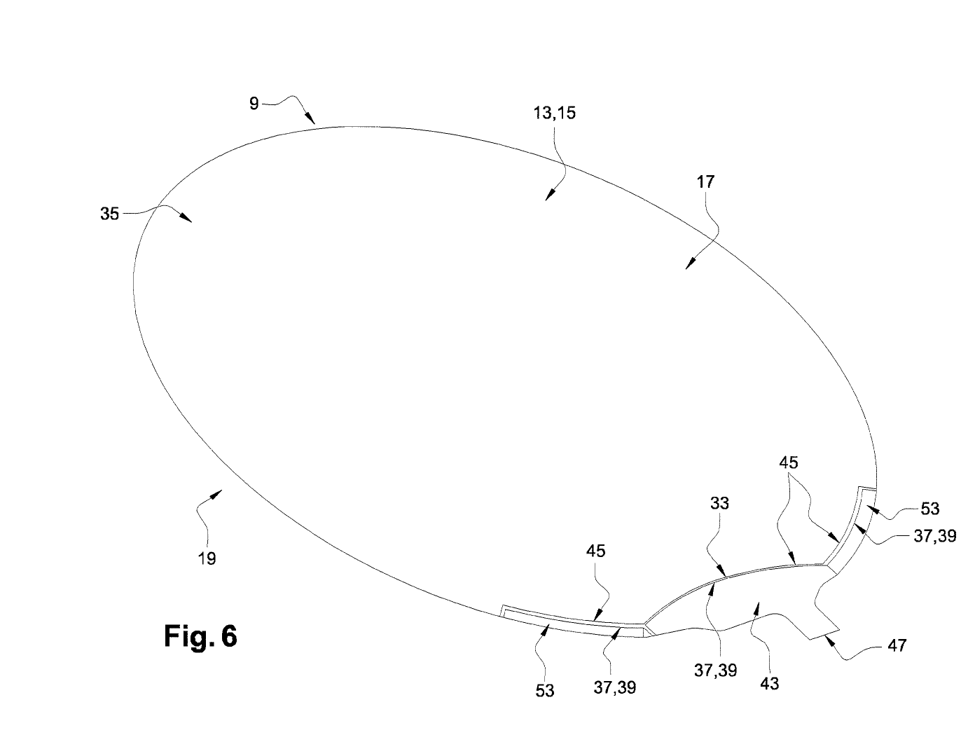

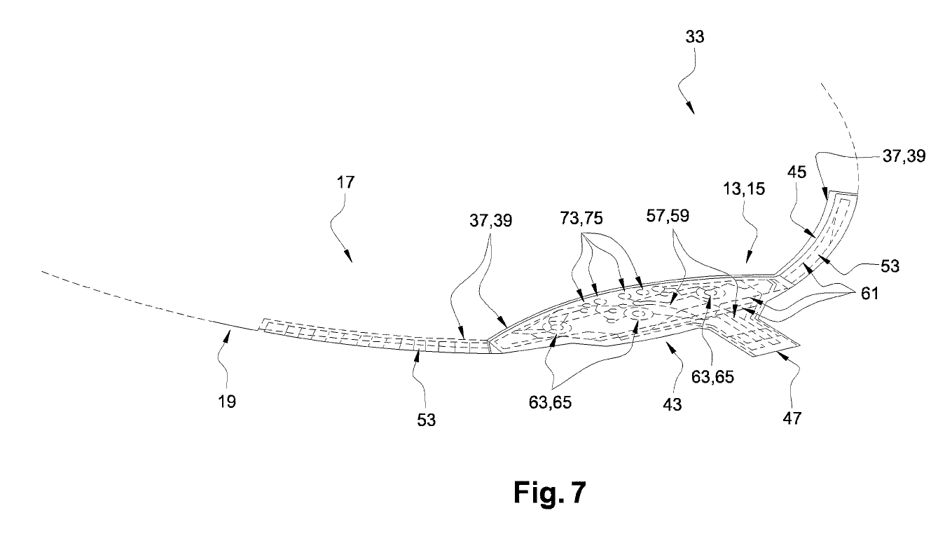

At the first end 33 of the interior trim window 9, the inner layer 21 comprises a connection station 37, as illustrated in FIGS. 6 and 7. The connection station 37 comprises a connection location 39 arranged along the thickness of the inner layer 21.

The connection station 37 comprises contact areas 41 intended to the power supply of the conductive layers 25. Each conductive layer 25 comprises a contact area 41.

As illustrated in FIGS. 6 and 7, the interior trim window 9 further comprises a control sub-assembly 43. The control sub-assembly 43 is applied onto the first end 33 of the interior trim window 9.

The maintaining ring 11 is facing the control sub-assembly 43 so that the maintaining ring 11 carries out a cowling of the control sub-assembly 43 with respect to the interior of the aircraft.

The control sub-assembly 43 comprises a first electrical link member 45 and a second electrical link member 47. The first 45 and the second 47 link members are made of flexible material. The control sub-assembly 43 is situated between the walls 17, 19, except the second electrical link member 47 which extends towards the exterior of the interior trim window 9.

The first electrical link member 45 presents an exterior shape complementary to the connection location 39. The first electrical link member 45 is secured to the docking station by bonding.

As illustrated in FIG. 10, the first electrical connection member 45 comprises connection terminals 49 to the contact areas 41 of the connection station 37. The bonding 51 allows both securing the control sub-assembly 43 to the connection station 37 and electrically linking the contact areas 41 to the connection terminals 49. FIG. 10 illustrates a bonding 51 between a conductive layer 25 and a connection terminal 49 of the first electrical connection member 45.

As illustrated in FIGS. 6 and 7, the first electrical connection member 45 comprises two side strips 53.

The second electrical connection member 47 extends outside the area facing the walls 17, 19 unlike the rest of the control sub-assembly 43, as illustrated in FIG. 7. The second connection member 47 extends substantially parallel to the exterior faces 15 of the panel 13. The second connection member 47 comprises a connection element to a power supply circuit.

As illustrated in FIG. 7, the control sub-assembly 43 comprises a flexible electrical circuit 55. The electrical circuit 55 further comprises a processing unit 57. According to the first embodiment, the processing unit 57 is a microprocessor. The microprocessor is arranged in the flexible electrical circuit 55.

The control sub-assembly 43 comprises a device 59 for applying a voltage to the terminals of the first connection member, the device being arranged in the flexible electrical circuit. The voltage applying device is linked to an external power supply by the second connection member.

The microprocessor and the voltage applying device 59 are connected, the microprocessor being arranged to drive the voltage applying device 59 so that the voltage applying device 59 varies the power supply to the terminals 49 of the first electrical link member 45. As illustrated in FIG. 10, the voltage applying device 59 is electrically linked to the first link member 45 by conductive tracks 61, the conductive tracks 61 being disposed in a conductive portion 60 of the flexible electrical circuit 55. The electrical circuit 55 also comprises an insulting portion 62.

The control sub-assembly 43 also comprises control elements 63 applied onto the flexible electrical circuit 55. The control elements 63 are linked to the microprocessor so as to allow a user to adjust the power supply of the conductive layers 25.

The control elements 63 comprise touch keys 65 arranged to be controlled by the user through the first wall 17, the touch keys 65 being activated by contact with an area of the first exterior face 15 facing the touch button 65. The touch keys 65 comprise inductive and/or capacitive sensors.

The control elements 63 comprise a first touch key 67 for the increase of the degree of opacity of the interior trim window 9, a second touch key 69 for the decrease of said degree of opacity and a third touch key 71 allowing at each press to alternate between a total opacity and the transparency of the interior trim window 9.

The control sub-assembly 43 also comprises signaling elements 73 applied onto the flexible electrical circuit 55. The signaling elements 73 comprise light-emitting diodes 75 visible through the first wall 17, as illustrated in FIG. 7.

The light-emitting diodes 75 are electrically linked to the microprocessor. The microprocessor is arranged to drive the illumination of the light-emitting diodes 75 according to the degree of opacity of the window. The number of illuminated light-emitting diodes 75 varies according to the degree of opacity of the interior trim window 9, the more opaque the interior trim window 9 is, the larger the number of illuminated light-emitting diodes 75.

The control sub-assembly 43 also comprises a screen printing 77 disposed on the flexible electrical circuit 55, as illustrated in FIG. 7. The screen printing 77 comprises indications intended for the user in order to specify the location of the touch keys 65 and their role. Openings are arranged in the screen printing to let the light-emitting diodes 75 apparent.

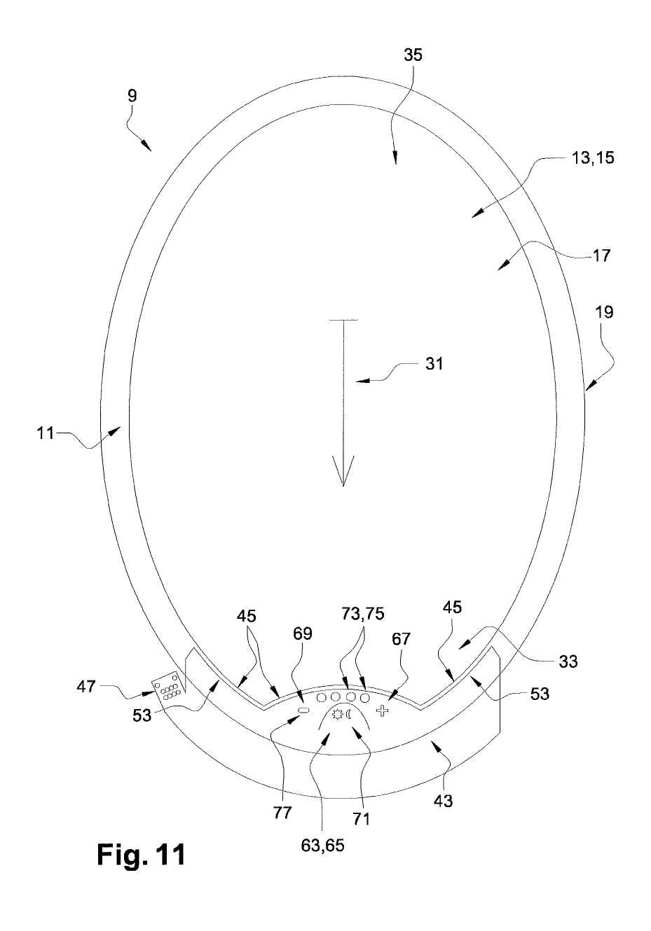

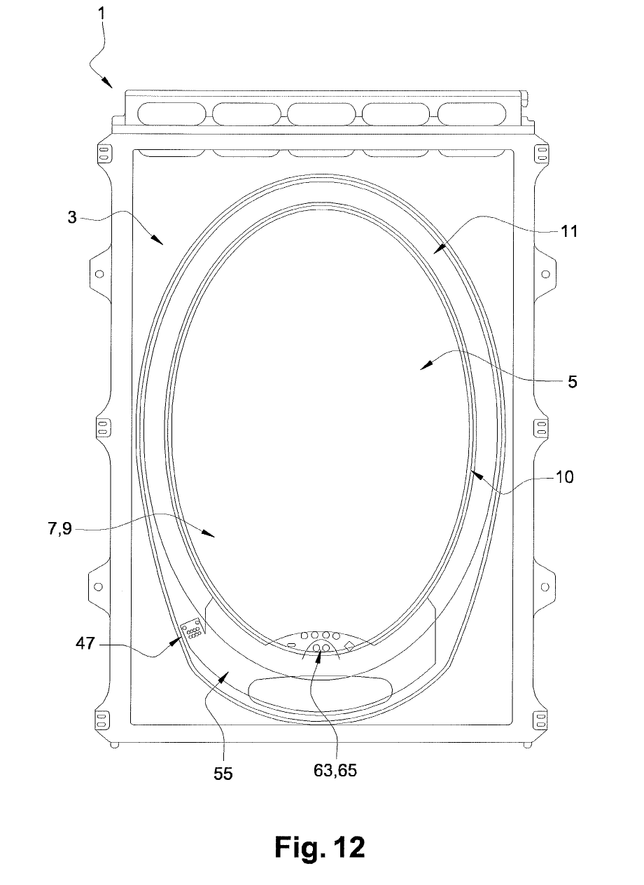

As illustrated in FIGS. 11 and 12, according to a second embodiment, the electrical circuit 55 has a portion outside the area facing the walls 17, 19. The electronic circuit 55 is partially rigid and partially flexible.

The rigid portion of the electronic circuit comprises the second electrical link member 47. The rigid portion of the electronic circuit 55 also comprises the processing unit 57 and the voltage applying device 59 for the transmission of electrical power to the conductive layers 25.

The flexible portion comprises the first electrical link member 45, the control elements 63 and the signaling elements 73.

The conductive tracks 61 are comprised both in the rigid portion and in the flexible portion.

Only the characteristics of the second embodiment different from the elements of the first embodiment are described below. The identical characteristics are not repeated.

The interior trim window 9 described above has advantages due to its design. The control sub-assembly 43 is applied onto the panel 13 of the interior trim window 9. The insertion of the interior trim window 9 into the housing 10 of the receiving cassette 3 is facilitated.

The installation of the interior trim window 9 in the receiving cassette 3 is quick and simple: this is done by simply positioning the interior trim window 9 in the dedicated location of the receiving cassette 3, joining the second electrical link member 47 to a power supply source and securing the interior trim window 9 with the maintaining ring 11.

For the maintenance operations, in particular in case of dysfunction in the adjustment of the opacity, the replacement of the defective interior trim window 9 by another interior trim window 9 turns out to be simple too thanks to the integration of the control sub-assembly 43 into the interior trim window 9.

The interior trim window 9 is also reliable because the control sub-assembly 43 is protected from the external environment by the maintaining ring 11.

Moreover, the electrical joining by bonding of the first electrical link member 45 to the connection station 41 is resistant. The risk of breakdown of the electrical connection is low.

It goes without saying that the invention is not limited to the sole embodiment of this system, described above as an example, it encompasses on the contrary all the variants.

1. An interior trim window forming a panel comprising at least one translucent wall and at least one polarizable film applied onto the wall and intended to modify the degree of opacity of the panel,
the interior trim window comprises further a device for applying a voltage to the polarizable film, the voltage applying device comprising at least one printed circuit provided with a flexible portion, the printed circuit and being linked to a power supply circuit,
the polarizable film comprising a plurality of superimposed layers having at least two conductive layers surrounding a layer made of polarizable material, the conductive layers being linked to the voltage applying device by at least one conductive track,
a portion of the printed circuit is disposed beyond the area facing the first exterior face of the panel, said portion being rigid and/or flexible.

2. The interior trim window according to claim 1, comprising a conductive track linked to a conductive layer of the polarizable film by bonding.

3. The interior trim window according to claim 1, wherein the polarizable film comprises a connection location having a contact area belonging to at least one conductive layer.

4. The interior trim window according to claim 3 comprising a first electrical link member presenting an exterior shape complementary to the connection location, the first electrical link member being applied onto the printed circuit.

5. The interior trim window according to claim 1, comprising control elements of the device for applying voltage to the polarizable film, the control elements being disposed so as to be operable by a contact on a first exterior face of the panel.

6. The interior trim window according to claim 5, wherein the control elements are integrated into the flexible portion of the printed circuit.

7. The interior trim window according to claim 1, comprising signaling elements.

8. The interior trim window according to claim 7, wherein the signaling elements comprise light elements.

9. The interior trim window according to claim 8, wherein the light elements are provided with light-emitting diodes.

10. The interior trim window according to claim 9, wherein the light-emitting diodes are applied onto the flexible portion of the printed circuit.

11. The interior trim window according to claim 1, wherein the flexible portion of the printed circuit comprises a processing unit arranged to drive the adjustment of the degree of opacity of the panel.

12. The interior trim window according to claim 1, wherein the flexible portion of the printed circuit extends opposite the first exterior face of the panel.

13. The interior trim window according to claim 1, wherein said portion of the printed circuit is rigid and comprises the voltage applying device.

14. A polarizable window system comprising a receiving cassette, and a trim window according to claim 1, the receiving cassette comprising a housing intended to receive at least part of the device for applying voltage to the polarizable film.
